(19) United States
(12) Patent Application Publication
(10) Pub. No.: US 2026/0330698 A1
(43) Pub. Date: Oct. 22, 2026

(54) METHOD, AN APPARATUS AND A COMPUTER PROGRAM PRODUCT FOR CODING OF INPUT DATA

(71) Applicant: Nokia Technologies Oy, Espoo (FI)

(72) Inventors: Nam Hai LE, Tampere (FI); Francesco CRICRÌ, Tampere (FI); Jukka Ilari AHONEN, Tampere (FI)

(21) Appl. No.: 19/555,715

(22) Filed: Mar. 3, 2026

Related U.S. Application Data
(60) Provisional application No. 63/767,348, filed on Mar. 5, 2025.

(51) Int. Cl. G06T 9/00; G06T 7/10

(52) U.S. Cl. CPC G06T 9/002; G06T 7/10

(57) ABSTRACT

The embodiments relate to an apparatus and a method. The method comprises receiving input data; partitioning the input data into two or more segments; processing each of said two or more segments in respective processing branches, said branches being different from each other, wherein each of the branches is configured to execute at least one of the following operation on an input: a) input-dependent processing, where a resulting output is dependent on the input; b) input-independent processing, where a resulting output is independent from the input; c) input passthrough, where a resulting output is the same or substantially the same as the input; and combining outputs of each of the branches to generate a final output.

### TECHNICAL FIELD

The present solution generally relates to coding of input data.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

An example of a codec is a video codec comprising an encoder and a decoder. The encoder transforms an input video into a compressed representation suited for storage and/or transmission. The decoder decompresses the compressed video representation back into a viewable form. During encoding, the encoder may discard some information in the original video sequence to be able to represent the video in a more compact form (that is, at lower bitrate).

Recently, neural networks have been used in the context of data compression.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus, comprising at least one processor, memory including computer program code, the memory and the computer program code configured to, with the at least one processor, cause the apparatus to perform at least the following: receive input data; partition the input data into two or more segments; process each of said two or more segments in respective processing branches, said branches being different from each other, wherein each of the branches is configured to execute at least one of the following operation on an input: a) input-dependent processing, where a resulting output is dependent on the input; b) input-independent processing, where a resulting output is independent from the input; c) input passthrough, where a resulting output is the same or substantially the same as the input; and combine outputs of each of the branches to generate a final output.

According to a second aspect, there is provided a method, comprising receiving input data; partitioning the input data into two or more segments; processing each of said two or more segments in respective processing branches, said branches being different from each other, wherein each of the branches is configured to execute at least one of the following operation on an input: a) input-dependent processing, where a resulting output is dependent on the input; b) input-independent processing, where a resulting output is independent from the input; c) input passthrough, where a resulting output is the same or substantially the same as the input; and combining outputs of each of the branches to generate a final output.

According to a third aspect, there is provided an apparatus comprising at least means for receiving input data; means for partitioning the input data into two or more segments; means for processing each of said two or more segments in respective processing branches, said branches being different from each other, wherein each of the branches is configured to execute at least one of the following operation on an input: a) input-dependent processing, where a resulting output is dependent on the input; b) input-independent processing, where a resulting output is independent from the input; c) input passthrough, where a resulting output is the same or substantially the same as the input; and means for combining outputs of each of the branches to generate a final output.

According to a fourth aspect, there is provided a computer program product comprising computer program code, which when executed by at least one processor, cause an apparatus or a system to perform at least the following: receive input data; partition the input data into two or more segments; process each of said two or more segments in respective processing branches, said branches being different from each other, wherein each of the branches is configured to execute at least one of the following operation on an input: a) input-dependent processing, where a resulting output is dependent on the input; b) input-independent processing, where a resulting output is independent from the input; c) input passthrough, where a resulting output is the same or substantially the same as the input; and combine outputs of each of the branches to generate a final output.

According to an embodiment, the input-dependent processing comprises a partition convolution or a padding operation or a gather operation; and wherein input-independent processing comprises a function returning constant values or a function returning data derived from other hyper-parameters.

According to an embodiment, processing of a branch is controlled with one or more respective first control signals.

According to an embodiment, the control signal is a learnable parameter with a value being obtained in a training process.

According to an embodiment, the control signal is an output of a neural network.

According to an embodiment, the one or more control signals are transmitted to a decoder.

According to an embodiment, combining comprises one or more of the following: concatenation, composition, element-wise summation, element-wise multiplication, linear combination.

According to an embodiment, the data is a frame, and the partition is rectangular cropping.

According to an embodiment, one of the segments comprises pixels or subpixels within a certain rectangle inside the boundary of the image or video frame, and one other of the segments comprises remaining pixels or subpixels.

According to an embodiment, the partition is performed based on a partitioning map indicating assignment of elements in said input data to one or more partitions.

According to an embodiment, at least a part of one or more partitioning maps is learned from training data.

According to an embodiment, at least a part of one or more partitioning maps is derived from input data.

According to an embodiment, a neural network generates a partition map from input data.

According to an embodiment, at least one of the segments is downsampled before performing the input-dependent processing and said at least one of the segments is upsampled after the input-dependent processing.

According to an embodiment, further being caused to control the downsampling and/or upsampling with a second control signal.

According to an embodiment, further being caused to transmit the second control signal to a decoder.

According to an embodiment, further comprising a channel adapter at least in one of the branches, said channel adapter configured to transform an input segment into a targeted output space if number of output channels is different than number of input channel.

According to an embodiment, being caused to determine the processing operation of a branch based on predefined information or information received from one or more external sources.

According to an embodiment, the input data is video being partitioned into one or more frames, whereupon the input passthrough is defined for branches processing frames preceding scene cuts.

According to an embodiment, being caused to signal the processing operation to a decoder.

According to an embodiment, the apparatus is arranged into an encoder.

According to an embodiment, wherein the apparatus is arranged into a decoder.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a convolutional neural network;

FIG. 2 shows an example of a video coding pipeline;

FIG. 3 shows an example of a traditional video coding pipeline with neural network-based components;

FIG. 4 shows an example of a neural network-based video coding pipeline;

FIG. 5 shows an example of a neural network-based end-to-end learned video coding system;

FIG. 6 shows an example of a multi-scale progressive probability model;

FIG. 7 shows an example of a prediction model in a multi-scale progressive probability model;

FIG. 8 shows an example of partition in a DIPE module;

FIG. 9 shows another example of partition in a DIPE module having two partition convolution modules;

FIG. 10 shows another example of partition in a DIPE module having two partition convolution modules;

FIG. 11a shows an example of a channel adapter;

FIG. 11b shows another example of a DIPE module having the channel adapter;

FIG. 12 shows another example of a DIPE module having a pointwise convolution;

FIG. 13 shows another example of a DIPE module making three partitions;

FIG. 14 shows another example of a DIPE module having a switch NN;

FIG. 15 shows another example of a DIPE module having a switch NN;

FIG. 16 shows another example of a DIPE module having different processing pipelines for different partition processing branches;

FIG. 17 shows another example of a DIPE module having shared parameters;

FIG. 18 is a flowchart illustrating a method according to an embodiment;

FIG. 19 shows an apparatus according to an embodiment; and

FIG. 20 shows an example of a multimedia communication system within which various embodiments may be implemented.

### DETAILED DESCRIPTION OF SOME EMBODIMENTS

The present embodiments relate to video encoding/decoding. In particular, the embodiments relate to learned codecs, and dynamic input partitions execution module.

The following description and drawings are illustrative. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

In the specification, terms “model” and “neural network” are used interchangeably and also the term “weight” may be referred to as “learnable parameter” or as “parameter”.

A neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

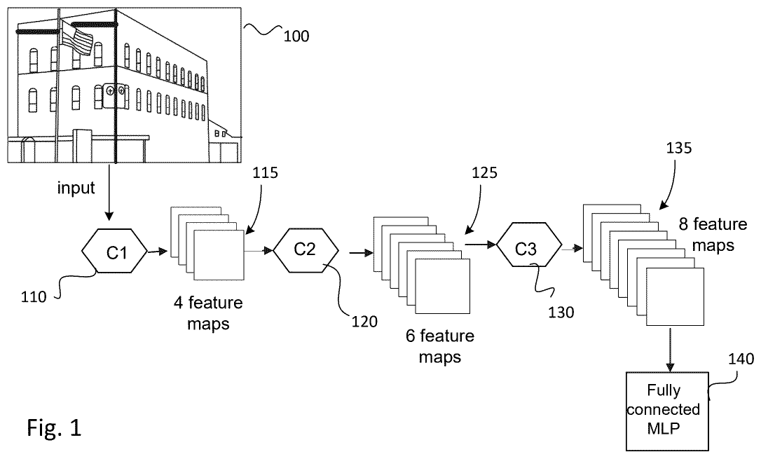

FIG. 1 shows an example of a neural network, a Convolutional Neural Network (CNN). This example of a CNN comprises one or more convolutional layers, fully connected layers, and a classification layer on top. CNNs are relatively easy to train compared to other deep neural networks and have fewer parameters to be estimated. Therefore, CNNs are highly attractive architecture to use, especially in image and speech applications.

In the example of FIG. 1, the input 100 to a CNN is an image, but any other data could be used as well. Each layer of a CNN represents a certain abstraction (or semantic) level, and the CNN extracts multiple feature maps. A feature map may for example comprise a dense matrix of Real numbers representing values of the extracted features. The CNN in FIG. 1 has only three feature (or abstraction, or semantic) layers 110, 120, 130 for the sake of simplicity, but CNNs may have more than three convolution layers.

The first convolution layer 110 of the CNN may comprise extracting 4 feature-maps 115 from the first layer (i.e. from the input image). These maps may represent low-level features found in the input image, such as edges and corners. The second convolution layer 120 of the CNN which may extract 6 feature-maps 125 from the previous layer, increases the semantic level of the extracted features. Similarly, the third convolution layer 130 may extract 8 feature-maps 135 from the previous layer may represent more abstract concepts found in images, such as combinations of edges and corners, shapes, etc. The last layer of the CNN, referred to as fully connected Multi-Layer Perceptron (MLP) 140 may include one or more fully connected (i.e., dense) layers and a final classification layer. The MLP 140 uses the feature-maps 135 from the last convolution layer 130 in order to predict (recognize) for example the object class. For example, it may predict that the object in the image is a house.

Two of the most widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more preceding layers, and provide output to one or more of following layers.

Initial layers (those close to the input data) extract semantically low-level features, such as edges and textures in images, and intermediate and final layers extract more high-level features. After the feature extraction layer there may be one or more layers performing a certain task, such as classification, semantic segmentation, object detection, denoising, style transfer, super-resolution, etc. In recurrent neural networks, there is a feedback loop, so that the neural network becomes stateful, i.e., it is able to memorize information or a state.

Neural networks are being utilized in an ever-increasing number of applications for many different types of device, such as mobile phones. Examples include image and video analysis and processing, social media data analysis, device usage data analysis, etc.

The most important property of neural networks (and other machine learning tools) is that they are able to learn properties from input data, either in supervised way or in unsupervised way. Such learning is a result of a training algorithm, or of a meta-level neural network providing the training signal. In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training may happen by minimizing or decreasing the output's error, also referred to as the loss. Examples of losses are mean squared error, cross-entropy, etc. In recent deep learning techniques, training is an iterative process, where at each iteration the algorithm modifies the weights of the neural network to make a gradual improvement of the network's output, i.e., to gradually decrease the loss.

Training a neural network is an optimization process, but the final goal is different from the typical goal of optimization. In optimization, the only goal is to minimize a function. In machine learning, the goal of the optimization or training process is to make the neural network learn the properties of the data distribution from a limited training dataset. In other words, the goal is to learn to use a limited training dataset in order to learn to generalize to previously unseen data, i.e., data which was not used for training the model. This may be referred as “generalization”. In practice, data may be split into at least two sets, the training set and the validation set. The training set is used for training the neural network, i.e., to modify its learnable parameters in order to minimize the loss. The validation set is used for checking the performance of the network on data, which was not used to minimize the loss, as an indication of the final performance of the neural network. In particular, the errors on the training set and on the validation set are monitored during the training process to understand the following things:
if the network is learning at all—in this case, the training set error should decrease, otherwise the model is in the region of underfitting.
if the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting This means that the model has just memorized the training set's properties and performs well only on that set, but performs poorly on a set not used for tuning its parameters.

Lately, neural networks have been used for compressing and de-compressing data such as image, i.e., an image codec. The most widely used architecture for realizing one component of an image codec is the auto-encoder, which is a neural network consisting of two parts: a neural encoder and a neural decoder. Neural encoder takes as input an image and produces a code which requires less bits than the input image. This code may be obtained by applying a binarization or quantization process to the output of the neural encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. The distortion metrics may be meant to be correlated to the human visual perception, or machine consumption. Minimizing or maximizing one or more of these distortion metrics results into improving the quality of the decoded image for the consumption.

Video codec consists of an encoder that transforms the input video into a compressed representation suited for storage/transmission, and a decoder that can be decompress the compressed video representation back into a viewable form. The encoder may discard some information in the original video sequence in order to represent the video in a more compact from (that is, at lower bitrate).

Some hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the predication error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction, the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder may reconstruct the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In some video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, they may be coded differentially with respect to block specific predicted motion vectors. In video codecs, the predicted motion vectors may be created in a predefined way, for example calculating the median of the encoded and decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted from adjacent blocks and/or or co-located blocks in temporal reference picture. Moreover, some high efficiency video codecs may employ an additional motion information coding/decoding mechanism, often called merging/merge mode. In the merging mode, all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In some video codecs, the prediction residual after motion compensation may be first transformed with a transform kernel (like DCT) and then coded. The reason for this is that often there still exists some correlation among the residual and transform can in many cases help reduce this correlation and provide more efficient coding.

Some video encoders may utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A design principle has been followed for SEI message specifications: the SEI messages are generally not extended in future amendments or versions of the standard.

Recently, neural networks (NNs) have been used in the context of image and video compression, by following mainly two approaches.

In one approach, NNs are used to replace one or more of the components of a traditional codec such as VVC/H.266. Here, “traditional” refers to those codecs whose components and their parameters are typically not learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

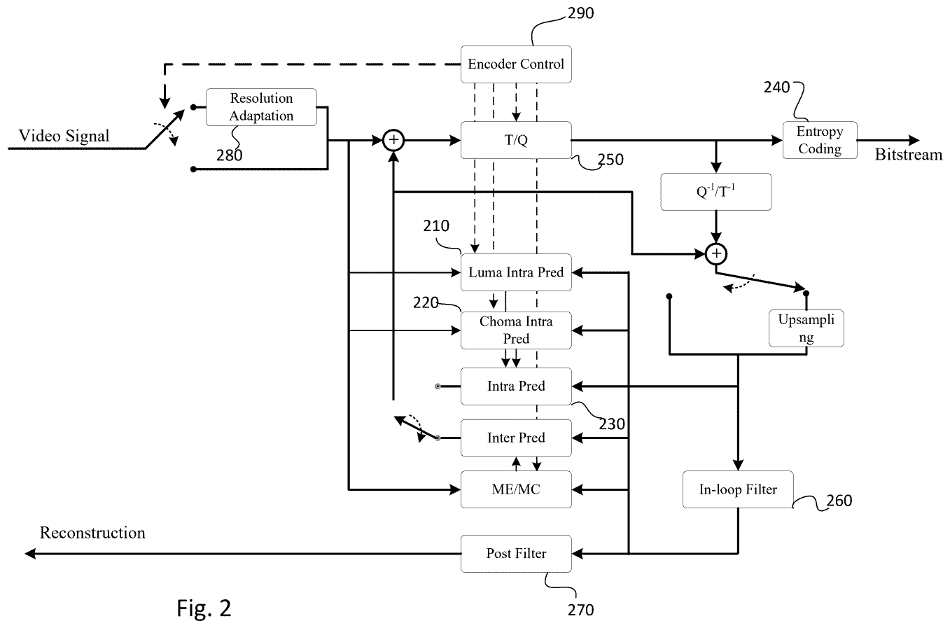

FIG. 2 illustrates examples of how NNs can function as components of a traditional codec's pipeline. FIG. 2 shows deep intra prediction neural network 210; deep cross component prediction neural network 220; deep inter prediction neural network 230; deep probability estimation neural network 240; deep transform neural network 250; deep loop filter 260; deep post filter 270; deep up-/down-sampling coding 280; and an optional deep encoder 290.

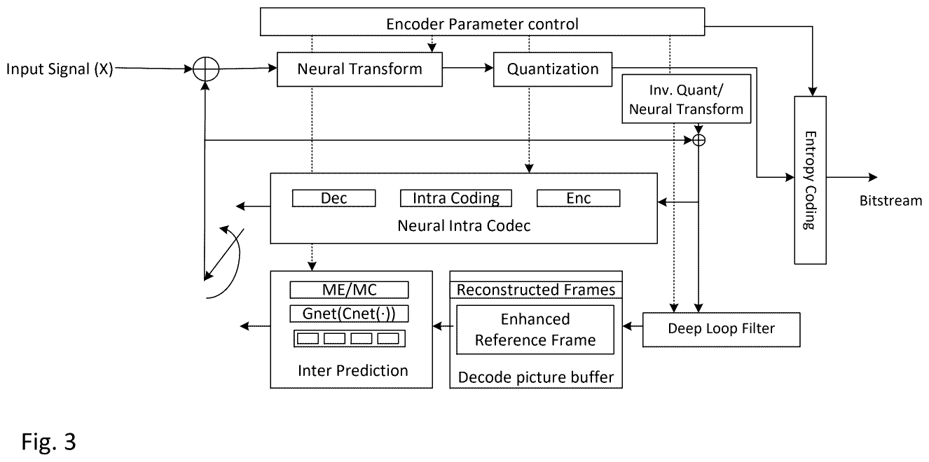

In another approach, commonly referred to as “end-to-end learned compression”, NNs are used as the main components of the image/video codecs. In this second approach, there are two main options:
Option 1: the traditional video coding pipeline is re-used, but most or all the components are replaced with NNs. This is illustrated in FIG. 3.
Option 2: the whole pipeline is re-designed as follows:
   Encoder NN: performs a non-linear transform
   Quantization and lossless encoding of the encoder NN's output.
   Lossless decoding and dequantization.
   Decoder NN: performs a non-linear inverse transform.

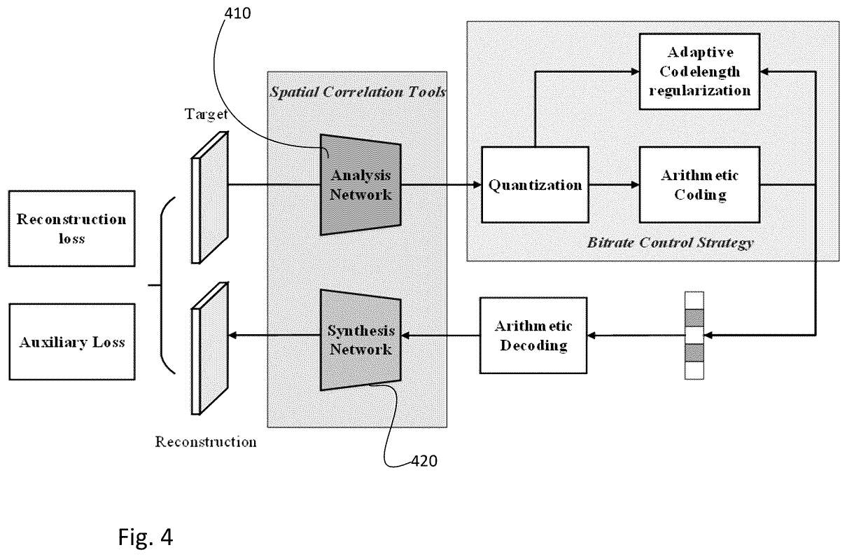

The encoder and decoder NNs may be parts of a neural auto-encoder architecture. FIG. 4 illustrates an example, where the Analysis Network 410 is the Encoder NN, the Synthesis Network 420 is the Decoder NN.

In the Option 2, the input data is analyzed by the Encoder NN (Analysis Network) 410, which outputs a new representation of that input data. The new representation may be more compressible. This new representation may then be quantized to a discrete number of values. The quantized data is then lossless encoded, for example by an arithmetic encoder, thus obtaining a bitstream. On the decoding side, the bitstream is first lossless decoded, for example by using an arithmetic decoder. The lossless decoded data is dequantized and then input to the Decoder NN (Synthesis Network) 420. The output is the reconstructed or decoded data. In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error(f1, f2), where f1 and f2 are the features extracted by a pretrained neural network for the input data and the decoded data, respectively, and error() is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. Term “compressing” refers to an operation of reducing the number of bits output by the encoding stage.

When an entropy-based lossless encoder is used, such as an arithmetic encoder, the rate loss may encourage the output of the Encoder NN to have low entropy. Example of rate losses are the following:
A differentiable estimate of the entropy.
A sparsification loss, i.e., a loss that encourages the output of the Encoder NN or the output of the quantization to have many zeros. Examples are L0 norm, L1 norm, L1 norm divided by L2 norm.
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights are usually considered to be hyper-parameters of the training session, and may be set manually by the person designing the training session, or automatically for example by grid search or by using additional neural networks.

It is to be noted that even in end-to-end learned approaches, there may be components which are not learned from data, such as the arithmetic codec.

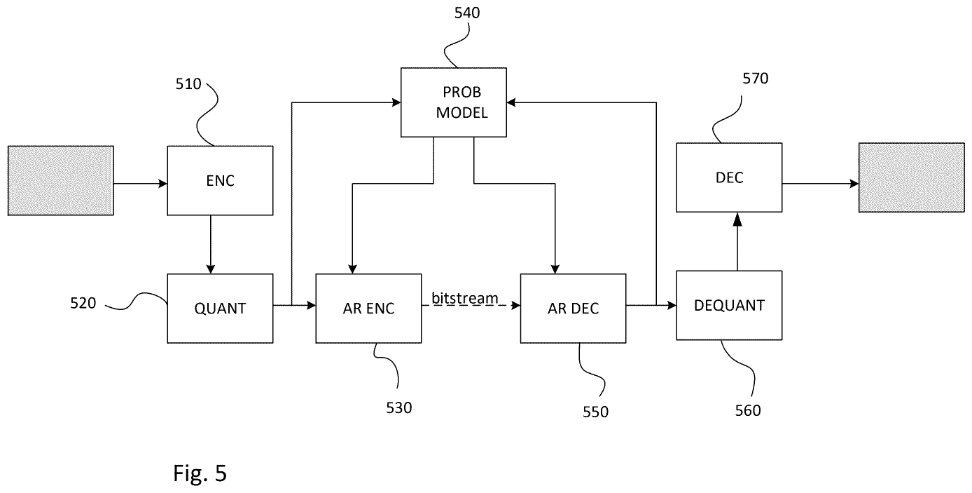

As shown in FIG. 5, a neural network-based end-to-end learned video coding system may contain a neural encoder 510, a quantizer 520, a probability model 540, entropy codec (for example arithmetic encoder 530 and arithmetic decoder 550), dequantizer 560, and a neural decoder 570. The neural encoder 510 and neural decoder 570 may comprise neural network components. The probability model 540 may also comprise neural network components. Quantizer 520, dequantizer 560 and entropy codec 530, 550 may not be based on neural network components, but they may comprise neural network components, potentially.

On neural encoder side, the neural encoder 510 component takes a video as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the neural encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). It is to be noted that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information. The quantizer component 520 is configured to quantize the latent representation into discrete values given a predefined set of quantization levels. Probability model 540 and arithmetic codec component 530, 550 work together to perform lossless compression for the quantized latent representation and generate bitstreams to be sent to the decoder side. Given an element in the quantized latent representation to be encoded into the bitstream, the probability model 540 estimates the probability distribution of all possible values for that element based on a context that is constructed from available information at the current encoding/decoding state, such as the data that has already been encoded/decoded. Then, the arithmetic encoder 530 encodes the input symbols to bitstream using the estimated probability distributions.

On the neural decoder side, opposite operations are performed. The arithmetic decoder 550 and the probability model 540 first decode elements from the bitstream to recover the quantized latent representation. Then, the dequantizer 560 is configured to reconstruct the latent representation in continuous values and pass it to neural decoder 570 to recover the input video/image. It is to be noticed that the probability model 540 in this system is shared between the encoding and decoding systems. In practice, this means that a copy of the probability model 540 is used at neural encoder side, and another exact copy is used at neural decoder side.

In the system of FIG. 5, the neural encoder 510, probability model 540, and neural decoder 570 may be based on deep neural networks. The system may be trained in an end-to-end manner by minimizing the following rate-distortion loss function:

L=D+λR,

where D is the distortion loss term, R is the rate loss term, and λ is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 540 and arithmetic encoder 530/arithmetic decoder 550. The system loss function contains only the rate loss, since the distortion loss is always zero (i.e., no loss of information).

A quantized latent representation is a 3-dimensional (or 4-dimensional for video compression) tensor, where two dimensions represent spatial information, one dimension represents the channel information, and another dimension represents temporal information in the 4-dimension case. The channel dimension captures information about a specific location or region of an input image or video. In the rest of this specification, it is assumed that the quantized latent representation is a 3-dimension tensor. The idea is naturally applicable to other dimensions. A pixel in a quantized latent representation is the vector along the channel dimension at a spatial position. It is to be noticed that a pixel, here, does not refer to a picture element, i.e., an element of the picture or image or frame which is input to the encoder; instead, a pixel is referring to a vector within the quantized latent representation, where the quantized latent representation is the output of a quantization operation applied on the output of an encoder.

The probability model 540 in a NN-based video coding system is responsible for giving an estimation of the probability distribution of the quantized latent representation. The probability distribution can be defined using a parametric model, where the probability distribution function is explicitly determined by a certain number of parameters, or a non-parametric model, where a system is trained to approximate the probability distribution function. The probability distribution estimation is used by the arithmetic encoder/decoder 530, 550 to compress/decompress the quantized latent representation. To achieve a better estimation, a probability model 540 normally processes the pixels in the quantized latent representation in a certain order, for example, a raster scan order or an order defined in a multi-scale mode. The pixels that have already been processed are used as context to achieve a better estimation for other pixels. To further enrich the context information, the probability model 540 may also choose to process the channels of each pixel separately. The channels that have already been processed are used as context to help the estimation of other channels. If channel A uses channel B as its context, this means that A is dependent on B. When channels A and B are not dependent on each other, this means that channel A and B are independent, i.e., channel A does not use channel B as context, and channel B does not use channel A as context.

In principle, an abundant context with more information can yield a better estimation of the probability distribution. However, the channel dependency mode directly affects the encoding and decoding speed. Channels that are independent of each other can be processed in parallel, which can be efficiently computed using hardware that supports parallel computing. Channels that are dependent on another set of channels must be processed after the channels on which they depend. For certain setups, a sequential dependency mode does not affect the encoding speed since all elements to be processed are available on the encoder side. However, in all setups, the decoding speed is inevitably affected by the dependency mode, which is a more serious problem for those use-cases where decoding speed is more important than encoding speed. Thus, a proper dependency mode is critical for achieving a balance of processing speed and estimation accuracy.

The probability model 540 is a critical component for a video coding system. It is responsible for giving probability distribution estimation of the quantized latent representation. Achieving a fast encoding/decoding speed while retaining the accuracy of the estimation is a challenging task. A sequential channel dependency mode may achieve an accurate estimation; however, the slow decoding speed limits its usage. On the other hand, when all channels are independent of each other and processed in parallel, the system achieves a fast decoding performance by sacrificing the compression rate.

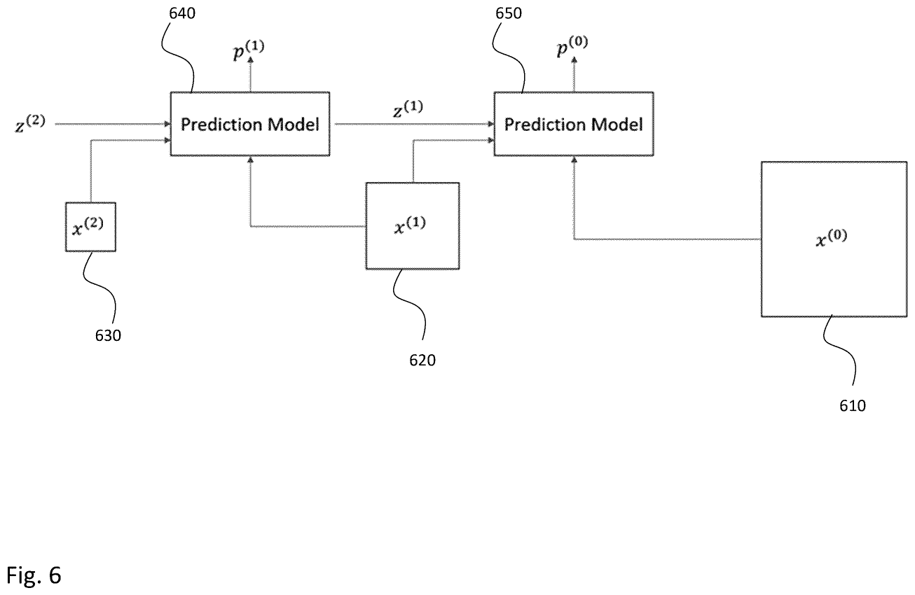

A multi-scale progressive probability model may partition the elements in a latent tensor into multiple groups. The elements in one group may be processed in parallel and the groups may be processed sequentially. FIG. 6 shows the architecture of a multi-scale progressive probability model at the encoding stage. Input latent tensor x⁽⁰⁾ 610 is first downsampled into a certain number of low-resolution representations, e.g. x⁽¹⁾, x⁽²⁾, 620, 630. The downsampling operation may use the nearest neighborhood, bilinear, or bicubic algorithm. If the downsampling algorithm is not the nearest neighborhood method, extra information may be transferred from the encoder to the decoder to recover round-off error due to the downsampling operation. The probability distribution of the elements in the representation at the lowest resolution, i.e. x⁽²⁾ 630 in FIG. 6, may be modeled as identically and independently distributed with a Gaussian distribution model, a uniform distribution model, or a mixture of probability distribution models. The probability of elements in the latent tensors in resolution levels other than the lowest one may be modeled by a conditional distribution model (whose parameters are estimated by a prediction model), where the conditioning information (also referred to as context or context information) may comprise the representation at lower resolution levels. In FIG. 6, z⁽ⁱ⁾ is an auxiliary output from the prediction model 640 at resolution level i where i=1,2, that may be used by the prediction model 650 at the next resolution level (i−1) as an extra input. z⁽²⁾ may be a zero tensor. p⁽ⁱ⁾ is the estimated parameters of the (conditional) probability distribution model for elements at resolution level i.

At the decoding stage, the latent tensor at the lowest resolution, i.e. x⁽²⁾ in FIG. 6 may be first decoded from the bitstream using the predefined probability distribution model. A multi-scale progressive probability model may use the elements in the latent tensor at resolution level i, e.g., x⁽ⁱ⁾, as the context to estimate the parameters of the distribution model for the elements in the latent tensor at a higher resolution level, e.g. x⁽ⁱ⁻¹⁾. The estimated probability distribution may be used by the arithmetic decoder to decode the elements in the bitstream to obtain the latent tensor at higher resolution level x⁽ⁱ⁻¹⁾. The procedure may be repeated until all elements in the latent tensor at the highest resolution level, i.e., x⁽⁰⁾, are decoded.

The prediction models at different resolution levels may share the weights or a subset of the weights. In one example, the prediction models at different resolutions are the same or substantially the same.

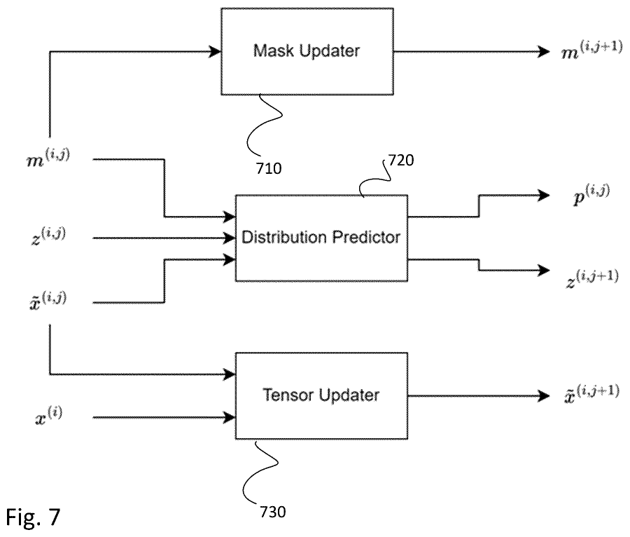

To further improve the accuracy of the probability distribution estimation, the elements in the latent tensor at a resolution level may be further partitioned into several groups. The partition may be performed in spatial dimensions, channel dimension, or the combination all dimensions. The groups may be processed sequentially. The elements in a group are modeled by independent conditional distribution models using the elements that have already been processed as the context. I.e., the elements of the latent tensor at a resolution level are processed in steps, where the elements in a group associated to a step are processed in parallel. The architecture of such prediction model is shown in FIG. 7.

Let N⁽ⁱ⁾ be the number of groups into which the elements in the latent representation at resolution level i are partitioned. FIG. 7 shows the prediction model at resolution level i and step j, where j=1, . . . , N⁽ⁱ⁾. The distribution predictor 720 predicts the parameters of the probability distribution for the elements in the latent representation at resolution level i and step j. z^{(i, j)} is the auxiliary input for the distribution predictor 720. For the first step, z^{(i,1)}=z⁽ⁱ⁺¹⁾, where z⁽ⁱ⁺¹⁾ is the auxiliary output from the resolution level i+1, i.e., z⁽ⁱ⁺¹⁾=z^{(i+1,N(i+1))}. \tilde{x}^{(i, j)} is a tensor that contains the true values for the elements that have already been processed and the predicted values of the elements that have not been processed at step j. \tilde{x}^{(i,1)} is derived by upsampling x⁽ⁱ⁺¹⁾. M^{(i, j)} is a binary-valued mask tensor with the same shape of \tilde{x}^{(i, j)} indicating the positions of the elements in \tilde{x}^{(i, j)} that have the true values. p^{(i, j)} is the estimated parameters of the probability distribution for the elements in group j at resolution level i. At the encoding stage, after p^{(i, j)} is calculated, the tensor updater component 730 may update the elements in group j with the corresponding true values in x⁽ⁱ⁾ to generate \tilde{x}^{(i, j+1)}, and the mask updater component 710 may update the mask tensor m^{(i, j)} accordingly to generate m^{(i, j+1)}. At the last step, i.e., j=N⁽ⁱ⁾, let z⁽ⁱ⁾=z^{(i, N}^{⁽ⁱ⁾}).

At the decoding stage, the calculated p^{(i, j)} is used to decode the corresponding elements in the bitstream. After a group of elements is decoded, the corresponding values are updated in \tilde{x}^{(i, j)} to generate \tilde{x}^{(i, j+1)} and mask tensor m^{(i, j)} is updated accordingly to generate m^{(i, j+1)}. The prediction model repeats this operation in N⁽ⁱ⁾ steps until all elements at the resolution level i are processed.

Execution costs of convolution operations may be reduced by skipping the processing on some pre-determined input channels, to allow faster inference time and to lower the requirements for computational resource.

The present embodiments provide alternative methods to reduce the execution cost of convolution operations. These methods relate to one or more of the following: partition input data, selectively processing the partitioned input data, training a convolution module and inference on the convolution module. The selective processing of the partitioned input data may comprise input-dependent processing, input-independent processing, or input passthrough. The input-dependent processing may comprise partition convolution, transformer block, linear layer, residual block, recurrent block, capsule operation, padding operation or gather operation, such as cropping, tensor slicing, masking, etc.

Furthermore, some of the methods according to present embodiments, can be applied to enhance the performance of convolution operations.

The present embodiments thus propose methods to reduce complexity of convolutions by performing an alternative operation or skipping the processing on a portion of the input data. In these methods, the input is first partitioned into different portions (also referred to as “segments”). Then, for every portion, the processing may or may not be carried out, based on a decision-making process. In addition, the training and inference methods of convolution modules are also discussed. Furthermore, some embodiments may be applied to enhance the performance of the convolution (e.g., in terms of a quality of a result or output of the convolution, such as in terms of MSE with respect to a target or ground-truth).

Some embodiments are discussed next in more detailed manner.

### General Information

In the following, 2D convolution is used to describe the methods. It should be noted that the embodiments can be applied to other types of convolutions, such as 1D or 3D convolutions, as well.

It should also be noted that some of the embodiments described herein may be applicable to other types of processing operations than convolutions, such as Transformer blocks or layers, recurrent blocks such as ConvLSTM, residual blocks, capsule layers, or Linear layers.

For simplicity, the term “execution cost” collectively refers to any of one or more types of resource requirements to execute a process. This includes, for example, time complexity, memory complexity, number of parameters, number of MACs (Multiply-accumulate operations), FLOPs (floating point operations) and runtime.

For simplicity, in at least some of the embodiments, the data type is image or video. However, the embodiments can be extended to other types of data such as audio, language embeddings or point cloud data.

While at least some of the embodiments refer to image or video data, these embodiments can also be extended to data that are associated or related to image or video data such as depth measurements and transparency information.

It is to be understood that also the term “block”, when it means a portion of a picture, may be simply referred to as “frame” or “picture” or “image”. In other words, at least some of the embodiments herein, even when described as applied to a picture, may be applicable also to a block, e.g., to a portion of a picture.

In at least some embodiments, these terms may be used interchangeably:
Image or picture or frame.
Signal or data or tensor.
Layers or neural network layers.
Domain or space, for example image domain or image space, feature domain or feature space.
Pixel domain or picture domain or image domain.
Latent or feature, for example latent space or feature space.
Partition or segment or portion, to refer to a subset of elements in a data tensor, such as an image, for example image partition or image segment.
Convolution or convolution module or convolution operation to refer to the entirety of a convolution operation that takes an input tensor and returns an output tensor.

In at least some embodiments hereinafter:
A “standard convolution” refers to a convolution operation in literature;
A “partition convolution” refers to a convolution operation, or a convolutional structure that includes one or more convolution operations, that processes an input partition or input segment;
A “Dynamic Input Partitions Execution” (DIPE) module, which will be described in the next sections, refers to a processing unit to be used in place of a standard convolution module or a convolutional structure that includes one or more standard convolutions. Examples of a convolutional structure includes a ResNet block, an Inception block, a Squeeze-and-excitation block, a separable convolution (e.g., a first convolution with kernel size 1×3 followed by a second convolution with kernel size 3×1).

In at least some of the following embodiments and examples, a DIPE module is presented as an analogous alternative to an original standard convolution, which refers to a corresponding standard convolution module or a convolutional structure that includes one or more standard convolutions. The DIPE module receives the same input data and maintains the same output shapes as the original standard convolution. However, a DIPE module may be used without, within or alongside convolutional structures that include one or more standard convolution modules.

### Some Embodiments

In one embodiment, at least one of one or more inputs to a DIPE module may be partitioned into one or more segments. The one or more segments are processed in different partition processing branches that may be comprised in the DIPE module, wherein each branch may process at least one of the one or more segments. For example, if a DIPE module comprises two processing branches, an image being partitioned into four quadrants can be processed as follows: two quadrants in the first branch and two quadrants in the second branch; or one quadrant in the first branch and three quadrants in the second branch; or three quadrants in the first branch and one quadrant in the second branch; or four quadrants in the first branch; or four quadrants in the second branch.

Each of the one or more branches may execute at least one of the following processing operations:
A processing pipeline whose output is dependent on the given one or more input segments, i.e., “input-dependent processing”, for example, a partition convolution or a padding operation.
A processing pipeline whose output is independent from the given one or more input segments, i.e., “input-independent processing”, for example, a function that returns constant values or a function that returns data derived from other hyper-parameters.
Passing through the input data i.e., “input passthrough”, which may be represented as applying an identity function. In other words, the output data is the same or substantially the same as the input data. For example, a copy operation may be performed, or a pointer to the input data may be used as a pointer to the output data.

The output of the DIPE module may be derived from a combination of the outputs of the partition processing branches. Examples for a combination operation could be concatenation, composition, element-wise summation, element-wise multiplication, linear combination or a mixture of them with cropping or trimming. In the following figures, concatenation is used as an example of combination. However, by understanding the various alternatives, it is appreciated that the concatenation can be replaced by any of the alternatives listed here.

In one embodiment, in at least one partition processing branch, there may be one or more controlling signals that dynamically compose the processing pipeline for that branch.

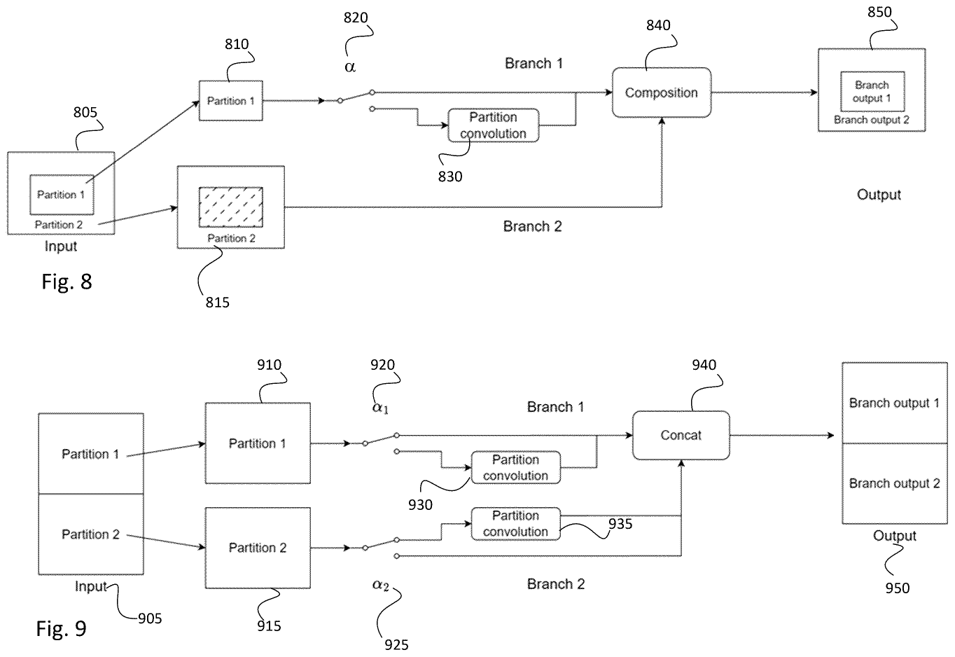

FIG. 8 illustrates an example, where a DIPE module partitions the input image 805 into two partitions 810, 815 via rectangular cropping. As a result of such process, a first partition 810 contains the pixels or subpixels within a certain rectangle inside the boundary of the input image and a second partition 815 contains the remaining pixels or subpixels. The controlling signal 820 denoted by α is a binary hyper-parameter of the DIPE module. Then, in the first partition processing branch (‘Branch 1’) which takes the first partition 810 as input, based on the value of α, either a partition convolution 830 (e.g., when α is equal to 1) or an identity function (e.g., when α is equal to 0) is applied to the first partition 810 to obtain the first branch output. In the second branch (‘Branch 2’), which passes through the second input partition 815, no processing is carried out. The output 850 of the DIPE module is obtained by inserting (or scattering) 840 the output of the first branch to the output of the second branch.

In one example, when the original standard 2D convolution has a stride of 2 both horizontally and vertically, the DIPE module partitions the input into non-overlapping 4 quadrants of equal size, which are then processed by partition processing branches that include partition convolutions with stride 1. The output of the module is a linear combination of the outputs of the 4 partition processing branches. In another example, the DIPE module partitions the input into overlapping 4 quadrants. The output of the module is obtained by first cropping the each of the branch outputs to the targeted output size, then linearly combining them.

FIG. 9 illustrates an example, where a DIPE module partitions the input 905 into two partitions 910, 915. The controlling signals 920, 930 denoted by α₁and α₂, respectively, are hyper-parameters of the DIPE module, which indicate whether the corresponding partition processing branch processes its input with a partition convolution 930, 935 or an identity function. The branch outputs are concatenated 940 to compose the DIPE output 950. The partition convolution blocks 930, 935 represent convolutional structures that process the branch inputs. In one additional example, the controlling signals α₁and α₂ may be independent of each other, e.g., α₁ may take any value independent of the value of α₂. In another additional example, the controlling signals α₁ and α₂ may be dependent on each other, e.g., when α₁ takes the value 1 then also α₂ takes the value 1, or when α₁ takes the value 1 then α₂ takes the value 0.

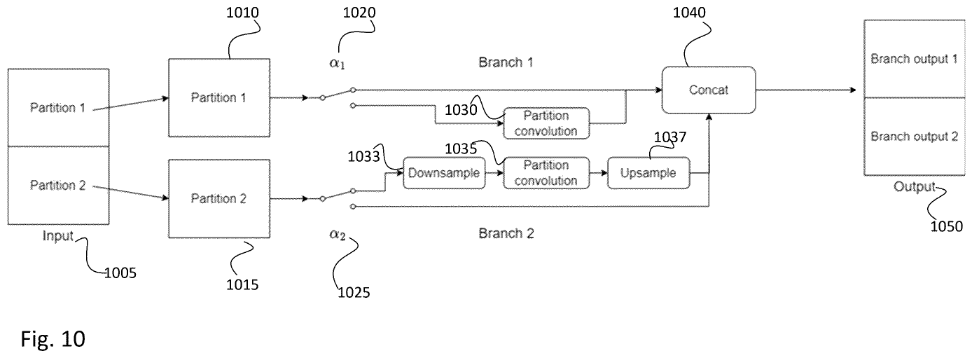

FIG. 10 illustrates another example, where the outputs of one or more partition processing branches are downsampled 1033 before partition convolution 1035 and upsampled 1037 back before the concatenation 1040. Otherwise FIG. 10 comprises the same elements as shown in FIG. 9.

In a related example, a control parameter β may decide in which branches the downsampling/upsampling are done as well as the ratios of downsampling/upsampling.

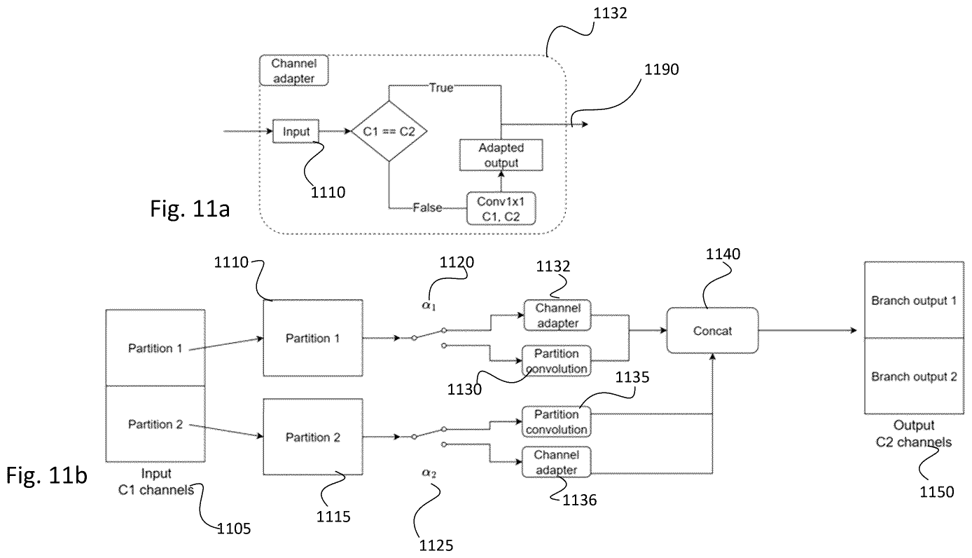

FIG. 11a shows an example of a channel adapter 1132, which is arranged into partition processing branch in the DIPE module, as shown in FIG. 11b. Both partition processing branches comprises a respective channel adapter 1132, 1136. As shown in FIG. 11b, the channel adapter 1132 uses a pointwise convolution (e.g., a convolutional layer with kernel size equal to 1×1) to transform the input partition 1110 to the targeted output space 1190 only if the number of output channels is different than the number of input channels for the original standard convolution.

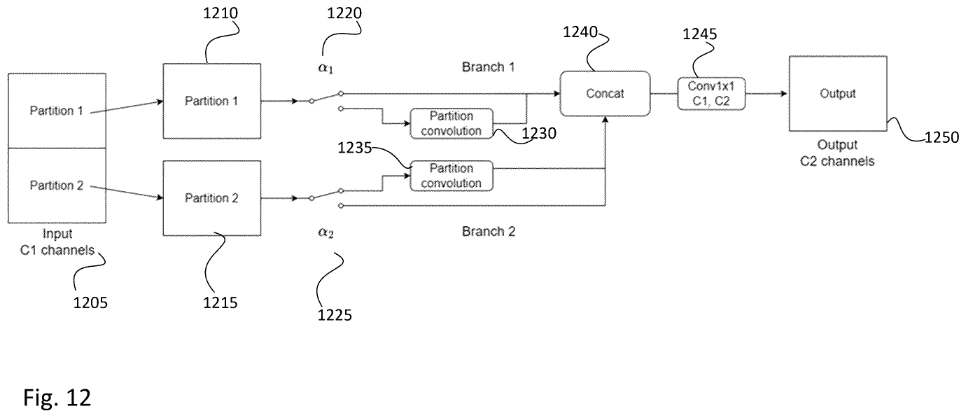

FIG. 12 shows yet another example, the branch outputs combination operator includes a pointwise convolution 1245 that transforms the concatenated tensor to the targeted output space 1250.

In one embodiment, there may be one or more information streams flow from one or more partition processing branches to one or more other partition processing branches.

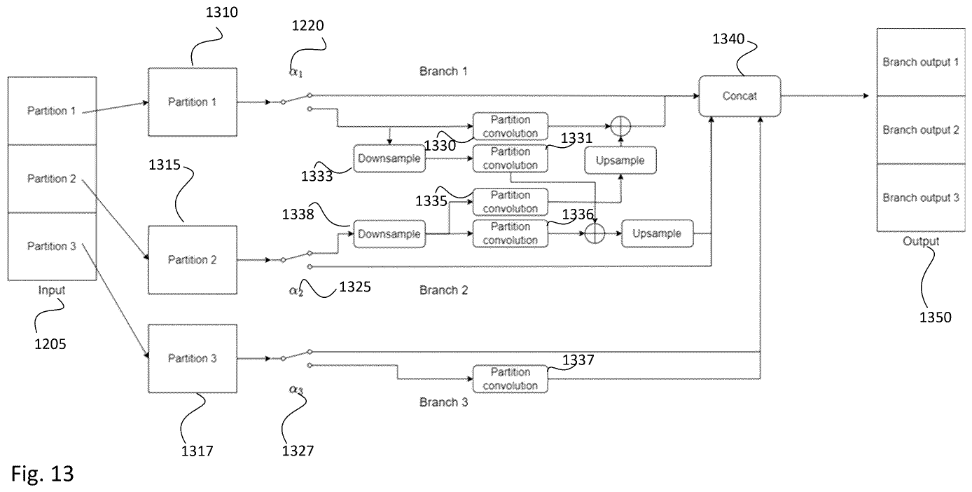

FIG. 13 illustrates an example having three partition processing branches (‘Branch 1’, ‘Branch 2’, ‘Branch 3’), where the first and second branches (‘Branch 1’, ‘Branch 2’) have information flows between them. There are two partition convolutions 1330, 1331; 1335, 1336 in each of the first and second branch. The first partition convolution 1330 of the first branch gets the first partition 1310 as its input. The second partition convolution 1331 of the first branch gets a downsampled 1333 first partition as its input. In the second branch, both the first and second partition convolutions 1335, 1336 get a downsampled 1338 second partition as their inputs. Before concatenation operation 1340, the output of the first partition convolution 1330 of the first branch is summed with the upsampled output of the first partition convolution 1335 of the second branch. Similarly, the output of the second partition convolution 1331 of the first branch is summed with the output of the second partition convolution 1336 of the second branch. In this example, α₁is equal to α₂.

In the third branch (‘Branch 3’), the processing comprises partition convolution 1337 that is performed based on a control signal α₃.

The outputs of the three branches are combined at the concatenation module 1340.

In another example, the downsampling operation of the second branch may be omitted if a partition method is used so that the resolution of the second partition matches the downsampled resolution of the first partition.

### Input Partitioning Methods

In one embodiment, one or more inputs to a DIPE module may be partitioned according to a certain specification or a representation of a specification (hereinafter referred to as partitioning maps), in which the elements of the one or more inputs may be assigned to one or more partitions (or segments). Examples for a partitioning map comprises:
an element-wise mask tensor that indicate the partition index for each of the input elements,
a tensor that may be used to derive the partition index for each of the input elements, such as a mask of a lower spatial resolution than the input tensor,
a sequence of integers that encodes the process of CTU and CU partitioning in VVC,
a tuple of scalars indicating the partition indices for the predefined segments of an input tensor,
a tuple of integers indicating the numbers of rows and columns of a partitioning grid,
a sequence of symbols encoding vertices of polygons.

Partitioning maps can be derived based on other decomposition methods to obtain different partitions, such as the following:
Splitting a tensor along the channel dimension into two or more tensors.
Splitting a tensor along the spatial dimension(s) into two or more tensors. For example, splitting a tensor into quadrants by splitting the tensor in both the height and width dimensions.
Block partitioning along multiple axes, such as splitting a tensor along the spatial dimensions and the channel dimension.
Hierarchical splitting of a tensor by using a recursive splitting function. For example, split a tensor into two halves, then split each half, and so on.
Quad-tree decomposition, where an input tensor is recursively split in the spatial dimension into four quadrants until a desired stopping criterion is satisfied, such as a minimum patch size is achieved.
Frequency-based decomposition, where an input tensor is first converted to frequency domain, e.g., by means of a Fourier Transform, or Discrete Cosine Transform, and then the input tensor is split into different frequency bands.
Splitting based on attention or importance scores. For example, given a tensor of attention scores, referred to as attention tensor, with same shape or size as an input tensor, channels of the input tensor associated with channels of the attention tensor that have high attention (according to a given threshold) would form one output sub-tensor, and all remaining channels of the input tensor would form another output sub-tensor.
Canonical Polyadic (CP) Decomposition.
Tucker decomposition.
Tensor Train decomposition.
Principal Component Analysis based decomposition.

It should be noted that as demonstrated by some examples above, a partitioning map may divide an input tensor, e.g., a video tensor, in spatial, temporal and channel dimensions. The partitions may be overlapping or non-overlapping.

In one embodiment, one or more partitioning maps, or parts of one or more partitioning maps may be randomly initialized. In another embodiment, one or more partitioning maps may be predefined (for example in a standard specification), or supplied by one or more external sources. In yet another embodiment, one or more partitioning maps may be signaled from an encoder to a decoder.

In one embodiment, one or more partitioning maps, or parts of one or more partitioning maps may be derived from the hyper-parameters of the original standard convolution and/or of the DIPE module. For example, when the original standard convolution has a stride of 2, the pixels with odd row or column indices in the input image are assigned to one partition and the rest is assigned to another partition.

In one embodiment, one or more partitioning maps, or one or more parts of one or more partitioning maps may be learned from training data. For example, a partition map may be optimized jointly with a DIPE module during its training phase.

In another embodiment, one or more partition maps, or one or more parts of one or more partitioning maps may be derived from at least the input data, such as by using a neural network that generates partition maps from the input data, for example an image segmentation network.

### Operation Selection Mechanism For Partition Processing Branches

As described in section “Some embodiments”, a partition processing pipeline may include (but may not be limited to): input-dependent processing, input-independent processing or input passthrough. The operation selection for a processing pipeline may be predefined, or dynamically decided by one or more controlling signals.

In one embodiment, in one or more partition processing branches, at least one operation selection may be predefined or supplied by one or more external sources. For example, when DIPE modules are used in a loop filter of a video codec, the input video data is partitioned into frames and the passthrough operation is predefined to be executed in the branches that process partitions (frames) preceding scene cuts. In another example, when a DIPE module is used in a learned video codec, the encoder can search for the optimal operations and signal the operation selection to the decoder.

In one embodiment, at least one operation of a partition processing branch may be randomly selected.

In one embodiment, in one or more partition processing branches, at least one controlling signal may be a learnable parameter whose value may be obtained via a training process.

In one embodiment, in one or more partition processing branches, at least one controlling signal may be an output of a learnable structure such as a neural network.

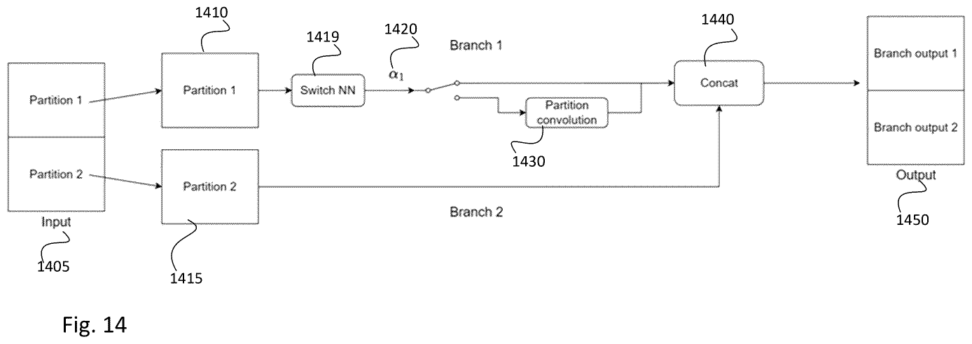

FIG. 14 illustrates an example, where a DIPE module partitions the input 1405 into two partitions 1410, 1415. A DIPE module comprises the switch neural network (Switch NN) 1419 that is given the input partition 1410 of the current branch as input and outputs the controlling signal 1420.

In an additional embodiment, the optimization process for at least one controlling signal or at least one learnable structure that outputs a controlling signal may utilize complexity loss terms that represent one or more types of execution cost with respect to the controlling signal. For example, given a controlling signal aₜ at training iteration t, the cost term could be the amount of memory consumed, or the reduction in memory consumption compared aₜ₋₁. The complexity loss terms may be minimized during the optimization process, where the optimization process may be part of a training process or of an overfitting process, where the training process is performed for training a neural network that comprises the DIPE module and is performed during a development phase of the neural network, and where the overfitting process is performed for finetuning or specializing a pretrained neural network or a randomly-initialized neural network on specific input data.

For example, given the DIPE module in FIG. 14 computational complexity for branch 1 could be represented by L_{c}=α₁*K*K*cᵢₙ*cₒᵤₜ, where α₁ is a binary value (0 for input passthrough; 1 otherwise) and K*K, cᵢₙ, cₒᵤₜ are kernel size, number of input channels and number of output channels of the partition convolution, respectively.

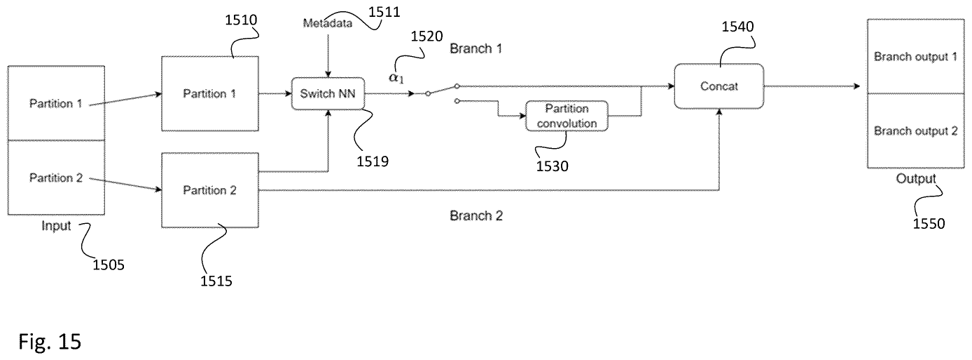

FIG. 15 illustrates another example, where the inputs to the switch NN 1519 include the first input partition 1510, the second input partition 1520 as well as other metadata 1511, such as hyper-parameters of the original standard convolution.

In another example, the inputs to the switch NN may include input partitions from multiple other branches or data derived from the input partitions of multiple different branches.

In one embodiment, one or more controlling signals may be discretized.

In one example, a switch NN outputs a real valued scalar which is then binarized by thresholding. In another example, a switch NN outputs a discrete distribution, e.g., by a Softmax function, then the controlling signal is realized by a sampling process, whose output is the index of the sampled bin.

### Partition Processing Operations

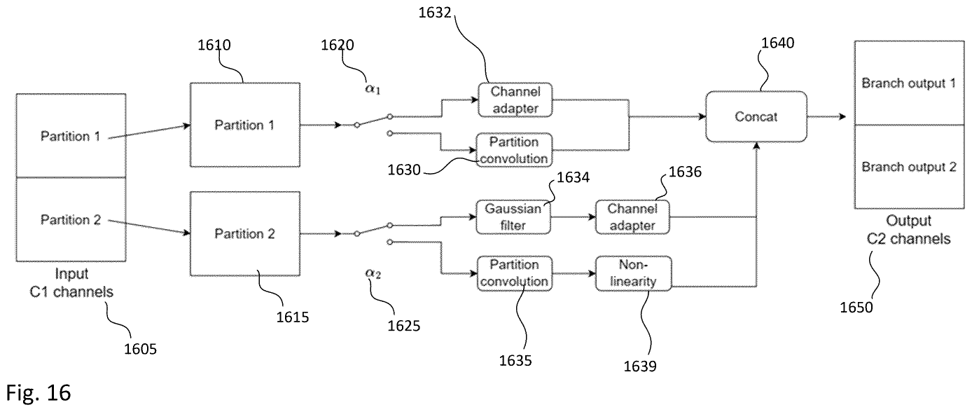

In some embodiments, a DIPE module may have different processing pipelines for different partition processing branches. One of such examples is shown in FIG. 16, where one of the branches comprises a partition convolution 1639 and channel adapter 1632, being controlled by a control signal 1620, and where another of the branches comprises a Gaussian filter 1634 with channel adapter 1636 and a partition convolution 1635 with non-linearity module 1639, being controlled by a control signal 1625.

In some embodiments, when one or more of the inputs are passed through, at least one of the branch outputs may be: a copy of the input; a reference of the input or a tensor that shares memory with at least some portions of the input.

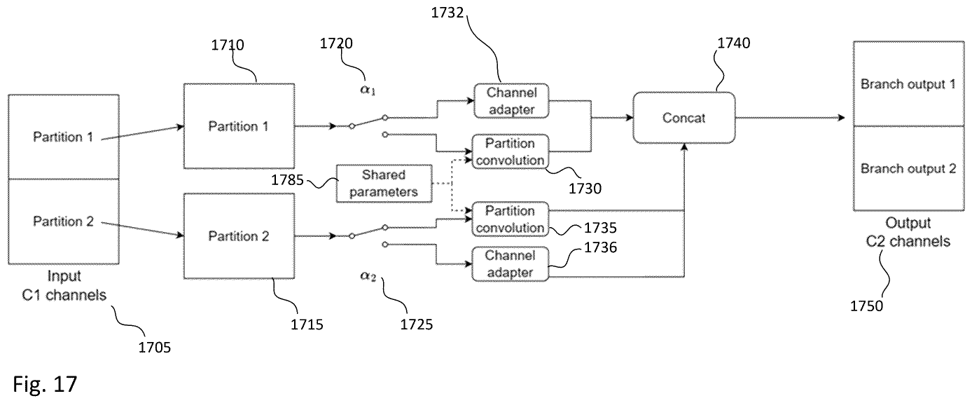

In some embodiments, two or more components of different partition processing branches may share a set or a subset of parameters. One of such example is shown in FIG. 17. In this example, at least some of the parameters of a first partition processing branch may have same or substantially same values as at least some of the parameters of a second partition processing branch. In one example, the processing branches in a DIPE module process their branch inputs with partition convolutions 1730, 1735 that share the same set of parameters 1785. In another example, the different partition convolutions 1730, 1735 share only the biases.

### Training and Inference Strategy

In one embodiment, one or more DIPE modules may replace one or more pretrained original standard convolutions at inference, where the partition convolutions may reuse the pretrained parameters or subsets of the pretrained parameters of the original standard convolutions.

In one embodiment, one or more parameters of a DIPE module may be randomly initialized.

In one embodiment, pretrained parameters or subsets of the pretrained parameters from an original standard convolution may be used to initialize one or more partition convolutions in DIPE module training process.

In one embodiment, one or more DIPE modules may be trained to replace one or more standard convolutions by aligning one or more of the intermediate and final outputs. For example, a structure of 2 back-to-back DIPE modules is trained to replace a structure of 2 back-to-back standard convolutions in a knowledge distillation scheme, in which the DIPE structure is the Student, and the standard convolution structure is the Teacher. The Student is trained to lower the mean squared error (MSE) between intermediate features of the first DIPE and output of the first standard convolution, and/or final output of the student and final output the Teacher.

In one embodiment, at training stage, the execution and/or the output of a DIPE module may be conditioned on auxiliary data, whose values may be sampled from continuous or discrete ranges. At inference stage, auxiliary signals may be given to control the outputs and/or the execution costs of the DIPE module.

In one example, the binarization threshold of a controlling signal in DIPE module can be used to control the number of floating-point operations at inference stage. At training stage, this signal can be randomly sampled from a range of values.

### OTHER EMBODIMENTS

In one embodiment, one or more DIPE modules may be used to replace one or more standard convolutions or convolutional structures, in order to reduce one or more types of execution cost, with or without increasing one or more other types of execution cost. In one example, a DIPE design that partitions its input into two partitions and always uses an Identity function on one of them effectively reduces roughly half of the number of floating-point operations (FLOPs). In another example, a DIPE module that processes the partitions with small RNN units and high number of iterations may reduce the memory complexity for storing a smaller amount of parameters, however the runtime and computational complexity may be higher than the original standard convolution.

Since DIPE may replace a standard convolution, the output of DIPE is processes similarly as the output of the standard convolution. For example, the output can be fed to a next convolution, to a next DIPE module, to a non-linearity layer, or simply returned as the output of the NN.

In one embodiment, the input of the DIPE module may be preprocessed by a Discrete Wavelet Transform (DWT) transformation. The partition maps may be constructed based on the composition of sub-band components in the DWT output. In one example, a tensor is input to a DWT operation, to obtain four decomposed tensors that may correspond to respective four sub-bands. The four decomposed tensors represent four partitions. Each of the four partitions may be processed in a different way, based on a predetermined (e.g., learned) way or based on an input-adaptive way. A first and a second decomposed tensors (that are part of the four decomposed tensors) may be processed by a particular convolutional layer, and a third and fourth decomposed tensors (that are part of the four decomposed tensors) may be passed through (no processing is applied). The processed first and second decomposed tensors and the third and fourth decomposed tensors are input to an inverse DWT operation that outputs an output tensor that represents an output of the DIPE module.

In one embodiment, an input tensor is input to a data shuffling module (e.g., PixelShuffle or PixelUnshuffle operations that are used in some neural network software libraries) to obtain a shuffled tensor, the shuffled tensor is decomposed or partitioned by means of one or more decomposition or partitioning methods (e.g., one of those described in other embodiments and examples) to obtain two or more decomposed or partitioned tensors, the two or more decomposed or partitioned tensors are input to respective two or more partition branches (e.g., first one or more of the two or more partitioned tensors are processed by a convolutional layer, and second one or more of the two or more partitioned tensors are passed through) to obtain respective two or more branch outputs, the two or more branch outputs are combined to obtain a combined tensor, and inputting the combined tensor to a data unshuffling module (e.g., PixelUnshuffle to the output of PixelShuffle or PixelShuffle to the output of PixelUnshuffle) to obtain a unshuffled tensor that may represent an output of the DIPE module, where the data shuffling module may shuffle (e.g., move) some of the elements in one or more dimensions of the input tensor to another one or more dimensions of the input tensor, and where the data unshuffling module may unshuffled (e.g., move back) some of the elements in one or more dimensions of the input tensor to another one or more dimensions of the input tensor. In one example, the data shuffling module is a PixelUnshuffle operation that re-arranges elements of an input tensor from the spatial dimensions to the channel dimension. When considering a patch of spatial size 2×2, the data shuffling module may re-arrange the 4 elements in the 2×2 patch to 4 different channels. In one example, the data unshuffling module is a PixelShuffle operation that re-arranges elements of an input tensor from the channel dimension to the spatial dimensions, such as re-arranging elements in 4 channels to a single channel. In one example, the shuffled tensor may be split along the channel dimension into two or more split tensors. In another example, the shuffled tensor may be first re-arranged in the channel dimension by shuffling the channels in a certain (predetermined or input-adaptive) way, and then the resulting tensor may be split along the channel dimension into two or more split tensors.

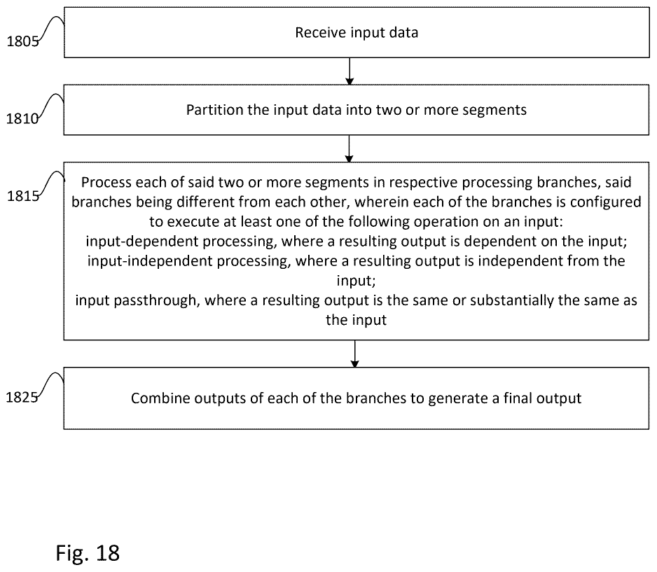

The method according to an embodiment is shown in FIG. 18. The method generally comprises receiving 1805 input data; partitioning 1810 the input data into two or more segments; processing 1815 each of said two or more segments in respective processing branches, said branches being different from each other, wherein each of the branches is configured to execute at least one of the following operation on an input:
a) input-dependent processing, where a resulting output is dependent on the input;
b) input-independent processing, where a resulting output is independent from the input;
c) input passthrough, where a resulting output is the same or substantially the same as the input;
   and combining 1825 outputs of each of the branches to generate a final output. Each of the steps can be implemented by a respective module of a computer system.

An apparatus according to an embodiment comprises means for receiving input data; means for partitioning the input data into two or more segments; means for processing each of said two or more segments in respective processing branches, said branches being different from each other, wherein each of the branches is configured to execute at least one of the following operation on an input:
a) input-dependent processing, where a resulting output is dependent on the input;
b) input-independent processing, where a resulting output is independent from the input;
c) input passthrough, where a resulting output is the same or substantially the same as the input;
   and means for combining outputs of each of the branches to generate a final output. The means comprises at least one processor, and a memory including a computer program code, wherein the processor may further comprise processor circuitry. The memory and the computer program code are configured to, with the at least one processor, cause the apparatus to perform the method of FIG. 18 according to various embodiments.

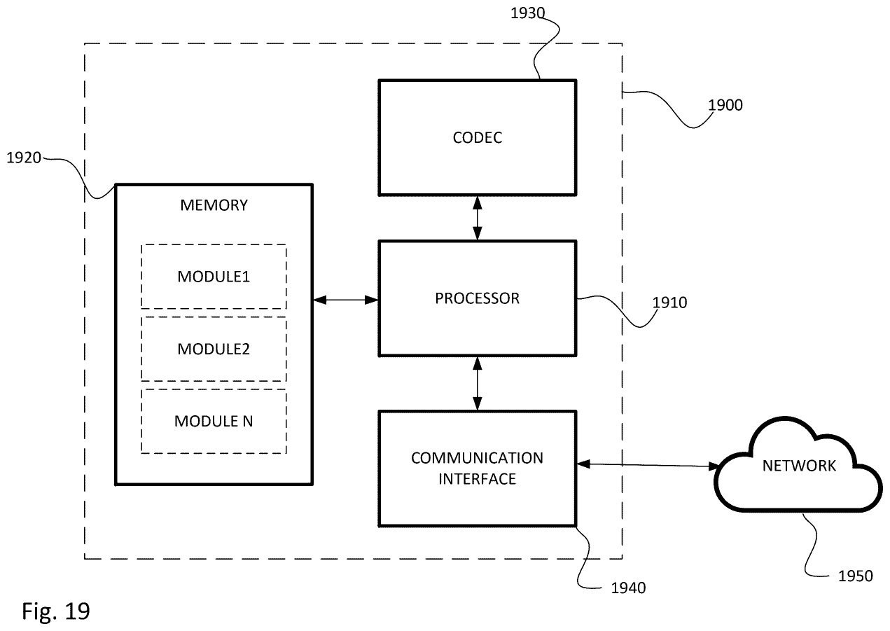

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 19. A computer-readable medium may comprise a computer-readable storage medium that may be any media or means that can contain or store the instructions for use by or in connection with an instruction execution system, apparatus, or device, such as a computer.

FIG. 19 illustrates an example of an electronic apparatus 1900, being an example of video coding system where the present embodiments can be implemented. In some embodiments, the apparatus may be a mobile terminal or a user equipment of a wireless communication system or a camera device. The apparatus 1900 may also be comprised at a local or a remote server or a graphic processing unit of a computer. The apparatus may also be comprised as part of a head-mounted display device.

The apparatus 1900 comprises one or more processors 1910 and one or more memories 1920 and one or more transceivers interconnected through one or more buses. The one or more memories 1920 store computer instructions, for example in respective modules (Module1, Module2, ModuleN). The one or more memories may store data in the form of image, video and/or audio data, and/or may also store instructions to be executed by the processors or the processor circuitry. The one or more processors may comprise a central processing unit (CPU) and/or a graphical processing unit (GPU). The one or more buses may be address, data or control buses, and may include interconnection mechanism, such as a series of lines on a motherboard or integrated circuit, fiber optics or other optical communication equipment. The apparatus also comprises a codec 1930 that is configured to implement various embodiments relating to present solution. According to some embodiments, the apparatus may comprise an encoder or a decoder. The apparatus 1900 also comprises a communication interface 1940 which is suitable for generating wireless communication signals for example for communication with a cellular communications network, a wireless communications system, or a wireless local area network, and thus enabling data transfer over data transfer network 1950.

The apparatus 1900 may comprise a display in the form of a liquid crystal display. In other embodiments of the invention the display may be any suitable display technology suitable to display an image or video. The apparatus 1900 may further comprise a keypad. In other embodiments of the invention any suitable data or user interface mechanism may be employed. For example, the user interface may be implemented as a virtual keyboard or data entry system as part of a touch-sensitive display. The apparatus 1900 may comprise a microphone or any suitable audio input which may be a digital or analogue signal input. The apparatus 1900 may further comprise an audio output device which in embodiments of the invention may be any one of: an earpiece, speaker, or an analogue audio or digital audio output connection. The apparatus 1200 may also comprise a battery (or in other embodiments of the invention the device may be powered by any suitable mobile energy device such as solar cell, fuel cell or clockwork generator). The apparatus may further comprise a camera capable of recording or capturing images and/or video. The camera may be a multi-lens camera system having at least two camera sensors. The camera is capable of recording or detecting individual frames which are then passed to the codec 1930 or to processor 1910. The apparatus may receive the video and/or image data for processing from another device prior to transmission and/or storage.

The apparatus 1900 may further comprise e.g., the other functional units disclosed e.g., with reference to FIGS. 2-17 for implementing any of the present embodiments.

The apparatus may operate in a system, comprising multiple communication devices, which can communicate through one or more networks. The system may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system can be a mobile telephone network enabling a connection to the internet. The connection can form, but is not limited to, long range wireless connections, short range wireless connections, and various wired connections including, but not limited to, telephone lines, cable lines, power lines, and similar communication pathways.

The example communication devices operating in the system may include, but are not limited to, an electronic device or apparatus, a combination of a personal digital assistant (PDA) and a mobile telephone, a PDA, an integrated messaging device (IMD), a desktop computer, a notebook computer, each of which can be a representative of the apparatus according to present embodiments. The apparatus according to present embodiments may be stationary or mobile when carried by an individual who is moving. The apparatus may also be located in a mode of transport including, but not limited to, a car, a truck, a taxi, a bus, a train, a boat, an airplane, a bicycle, a motorcycle, or any similar suitable mode of transport.

The apparatus may also be a set-top box; i.e. a digital TV receiver, which may/may not have a display or wireless capabilities, a tablet or (laptop) a personal computer (PC), which have hardware or software or combination of the encoder/decoder implementations, in various operating systems, or a chipset, processor, DSP and/or embedded system offering hardware/software based coding.

The apparatus according to present embodiments may send and receive calls and messages and communicate with service providers through a wireless connection to a base station. The base station may be connected to a network server that allows communication between the mobile telephone network and the internet.

The apparatus may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

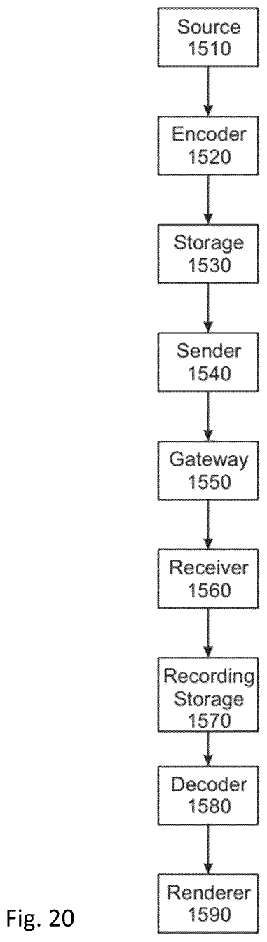

FIG. 20 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be encoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random-access memory. The format of the coded media bitstream in the recording storage 2170 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g., for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1580 is discussed to simplify the description without a lack of generality.

The coded media bitstream may be processed further by a decoder 1580, whose output is one or more uncompressed media streams. Finally, a renderer 1590 may reproduce the uncompressed media streams with a loudspeaker or a display, for example. The receiver 1560, recording storage 1570, decoder 1580, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally, or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

A decoder 1580 may be configured to perform switching between different representations e.g., for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, some embodiments have been described with reference to and/or using terminology of HEVC and/or VVC. It needs to be understood that embodiments may be similarly realized with any video encoder and/or video decoder.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising at least one processor, memory including computer program code, the memory and the computer program code configured to, with the at least one processor, cause the apparatus to perform at least the following:
receive input data;
partition the input data into two or more segments;
process each of said two or more segments in respective processing branches, said branches being different from each other, wherein each of the branches is configured to execute at least one of the following operation on an input:
a) input-dependent processing, where a resulting output is dependent on the input;
b) input-independent processing, where a resulting output is independent from the input;
c) input passthrough, where a resulting output is the same or substantially the same as the input;
combine outputs of each of the branches to generate a final output.

2. The apparatus according to claim 1, wherein the input-dependent processing comprises a partition convolution or a padding operation or a gather operation; and wherein input-independent processing comprises a function returning constant values or a function returning data derived from other hyper-parameters.

3. The apparatus according to claim 1, further being caused to control processing of a branch with one or more respective first control signals.

4. The apparatus according to claim 3, wherein the control signal is a learnable parameter with a value being obtained in a training process.

5. The apparatus according to claim 3, wherein the control signal is an output of a neural network.

6. The apparatus according to claim 3, further being caused to transmit the one or more control signals to a decoder.

7. The apparatus according to claim 1, where combining comprises one or more of the following: concatenation, composition, element-wise summation, element-wise multiplication, linear combination.

8. The apparatus according to claim 1, where data is a frame, and the partition is rectangular cropping.

9. The apparatus according to claim 8, where one of the segments comprises pixels or subpixels within a certain rectangle inside the boundary of the image or video frame, and wherein one other of the segments comprises remaining pixels or subpixels.

10. The apparatus according to claim 1, further being caused to perform the partition based on a partitioning map indicating assignment of elements in said input data to one or more partitions.

11. The apparatus according to claim 10, further being caused to learn at least a part of one or more partitioning maps from training data.

12. The apparatus according to claim 10, further being caused to derive at least a part of one or more partitioning maps from input data.

13. The apparatus according to claim 12, further comprising a neural network to generate a partition map from input data.

14. The apparatus according to claim 1, further being caused to downsample at least one of the segments before performing the input-dependent processing and caused to upsample said at least one of the segments after the input-dependent processing.

15. The apparatus according to claim 14, further being caused to control the downsampling and/or upsampling with a second control signal.

16. The apparatus according to claim 15, further being caused to transmit the second control signal to a decoder.

17. The apparatus according to claim 1, further comprising a channel adapter at least in one of the branches, said channel adapter configured to transform an input segment into a targeted output space if number of output channels is different than number of input channel.

18. The apparatus according to claim 1, further being caused to determine the processing operation of a branch based on predefined information or information received from one or more external sources.

19. A method for encoding comprising at least the following:
receiving input data;
partitioning the input data into two or more segments;
processing each of said two or more segments in respective processing branches, said branches being different from each other, wherein each of the branches is configured to execute at least one of the following operation on an input:
a) input-dependent processing, where a resulting output is dependent on the input;
b) input-independent processing, where a resulting output is independent from the input;
c) input passthrough, where a resulting output is the same or substantially the same as the input;
combining outputs of each of the branches to generate a final output.

20. The method according to claim 19, wherein the input-dependent processing comprises a partition convolution or a padding operation or a gather operation; and wherein input-independent processing comprises a function returning constant values or a function returning data derived from other hyper-parameters.
